(19) United States
(12) Patent Application Publication
(10) Pub. No.: US 2011/0096544 A1
(43) Pub. Date: Apr. 28, 2011

(54) ILLUMINATION DEVICE

(75) Inventor: Hirozumi Nakamura, Ehime (JP)

(73) Assignee: HARISON TOSHIBA LIGHTING CORPORATION, Imabari-shi, Ehime (JP)

(21) Appl. No.: 13/002,011

(22) PCT Filed: Jul. 1, 2009
(86) PCT No.: PCT/JP2009/003053

§ 371 Date: Dec. 29, 2010

(30) Foreign Application Priority Data
Jul. 1, 2008 (JP) 2008-172390

(51) Int. Cl. F21V 7/00

(52) U.S. Cl. 362/235

(57) ABSTRACT

Provided is an illumination device which is designed to have increased brightness, to provide a uniform light distribution, and to provide a thinner form to an illumination device employing an LED light source, and is equipped with direct illumination and indirect illumination functions. In the illumination device, a hollow light guide region (7) for guiding light emitted from an LED (4) is formed between a clear cover (1) and a back frame (3), and a gap (2) is formed between an LED assembly holder (6) of the back frame (3) and a side wall (1b) of the clear cover (1) opposite the holder (6).

### TECHNICAL FIELD

The present invention relates to an illumination device having a flat lighting source used for room lighting or flat advertising display signboard.

### BACKGROUND ART

In the field of the room lighting in houses, it is not only important to make rooms bright by illumination, but also the room atmosphere produced from the illumination is more important in general. For this reason, indirect illumination by which emission light from light source does not enter directly into eyes of people in the room, is used appropriately in addition to direct illumination. The indirect illumination is used as a sole lighting source in some cases. However, in many cases at dwelling houses, indirect illumination and direct illumination are used at the same time, or indirect illumination and direct illumination are used selectively for a reason of maintenance fees.

Regarding the light sources used in the illumination devices, the recent trend is from incandescent lamps or fluorescent light bulbs to LEDs. The main reason is that LEDs are well suited for environment-conscious light source because they do not contain harmful substance mercury. Besides, electric power consumption is drastically reduced because of recent significant light emitting efficiency rise of LEDs. Furthermore, LEDs generally have advantages such as long life, high efficiency, high crashproof, and monochromatic radiation etc.

There are many illumination devices for general lightings developed and commercialized by using a white LED as a light source. With respect to a configuration of the illumination devices, such devices are widely used in which gaps are provided between ceiling and illumination device for leaking light toward the ceiling to be reflected downward as an indirect illumination for being added to direct illumination.

### SUMMARY OF INVENTION

### Technical Problem

However, it is difficult to provide a flat illumination surface when the LED is used as a light source in illumination devices, especially when small number of LEDs are used. The reason is because the emitted lights from LED have different radiation strength depending on their radiation angles, and thus a distribution of the radiation strength is not uniform. Therefore, application of the illumination devices using small number of LEDs is limited to such devices as down lights for spot illumination, and is not proper to devices having a plane illumination surface as a general room illumination.

Further, cost of producing the illumination devices became inevitably high because a number of LEDs is needed to be arranged in arrays in the plane illumination devices.

It is thus an object of the present invention to resolve above mentioned problems, to supply an illumination device capable of converting the LED light source illumination into high luminance, uniform light distribution, and to supply a thin type plane illumination device with high efficiency, equipped with direct illumination and indirect illumination.

### Solution to Problem

The illumination device according to the embodiment of the present invention includes a translucent clear cover in the periphery of a light emitting plane having a side wall portion folded down from the light emitting plane, a back frame placed in the clear cover with a reflecting plane facing the light emitting plane of the clear cover, and an LED assembly held at the end portion of the back frame having a plurality of LEDs mounted thereon, wherein a hollow light guide region for conducting the light radiated from the LED assembly is formed between the clear cover and the back frame, and a gap is formed between the LED assembly holder of the back frame and the side wall of the clear cover opposite to the holder.

In the illumination device according to the embodiment of the present invention, the clear cover is formed in a lid configuration having a bottom portion forming the light emitting plane and a side wall portion folded down from the bottom portion, the back frame is formed in a mountain configuration having a slope gradually lowering from the top portion to the periphery, and the LED assembly holder arranged substantially in a vertical direction so as to surface the side wall portion of the clear cover with a gap.

Further, a reflecting surface is formed on the mountain shaped slope of the back frame facing the clear cover in the illumination device according to the embodiment of the present invention.

Further, a collimator for condensing the emitted light from the LED assembly is arranged on the light emitting side of the LED assembly mounted on the LED assembly holder in the illumination device according to the embodiment of the present invention.

Travelling direction of the light emitted from the collimator is substantially parallel with the light emitting surface of the clear cover in the illumination device according to the embodiment of the present invention.

### ADVANTAGEOUS EFFECTS OF INVENTION

According to the illumination device of the present invention, a LED light source illumination device is provided having high luminance, uniform light distribution, and thin type plane illumination with high efficiency, and equipped with direct illumination as well as indirect illumination.

### BRIEF DESCRIPTION OF THE DRAWINGS

FIG. 1 is a sectional side view of an illumination device showing an embodiment according to the present invention.

FIG. 2 is an exploded perspective view of the illumination device showing the embodiment according to the present invention.

FIG. 3 is a sectional side view of an LED assembly composing the illumination device showing the embodiment according to the present invention.

FIG. 4 is a schematic perspective drawing of the LED collimator composing the illumination device showing the embodiment according to the present invention.

FIG. 5 is a schematic sectional side view of a light path of the LED collimator composing the illumination device showing the embodiment according to the present invention.

FIG. 6A and FIG. 6B are schematic diagrams comparing the light paths of emitted light from the LED when the LED collimator composing the illumination device showing the embodiment according to the present invention is used and when it is not used. FIG. 6A shows the light paths when the LED collimator is not used, FIG. 6B shows the light paths when the LED collimator is used.

FIG. 7 is a schematic diagram showing the example of light distribution of the illumination device shown in FIG. 6A and FIG. 6B.

FIG. 8 is a schematic diagram showing light paths of the illumination device shown in FIG. 6B.

FIG. 9A and FIG. 9B are enlarged perspective views showing a surface configuration of a clear cover composing the illumination device shown in FIG. 6A and FIG. 6B.

FIG. 10A and FIG. 10B are schematic diagrams showing the paths of light entered into the clear cover composing the illumination device shown in FIG. 6A and FIG. 6B. FIG. 6A and FIG. 6B show the paths of light each entered with the different incident angles respectively.

FIG. 11 is an arrangement plan showing another embodiment of the illumination device according to the present invention.

### DESCRIPTION OF EMBODIMENTS

Hereinafter embodiments of the illumination device according to the present invention will be explained referring to the figures appended.

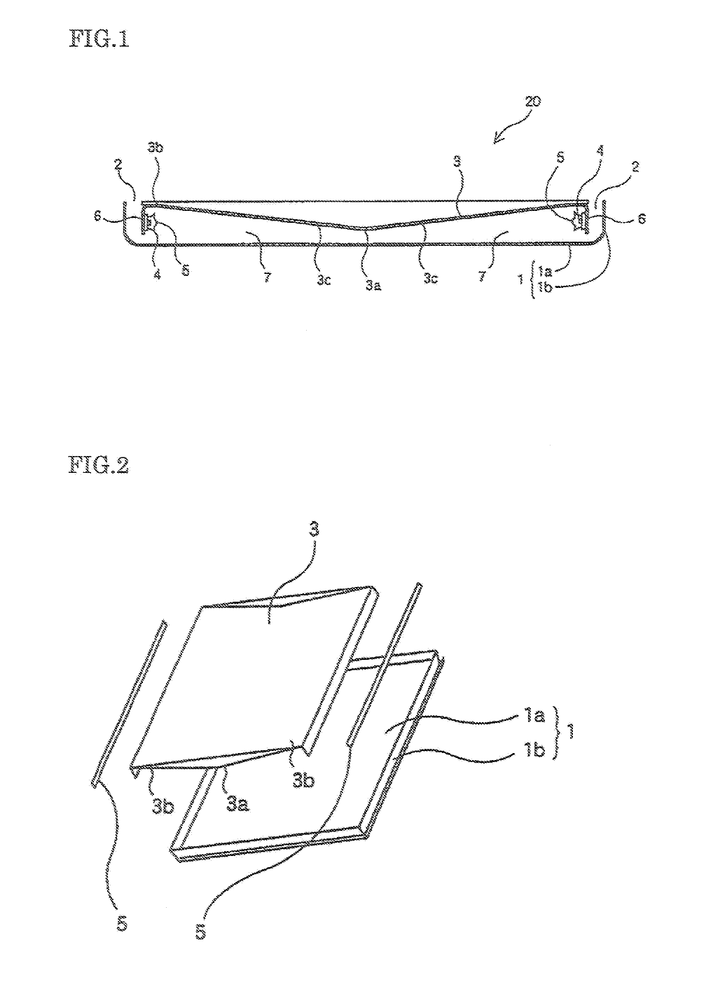

FIG. 1 is a sectional side view of an illumination device showing an embodiment according to the present invention, and FIG. 2 is an exploded perspective view thereof.

Illumination device 20 is a flat illumination device of a side-light type with light sources arrayed on an end portion of a light emitting member having light emitting surface. More specifically, the light emitting member is a lid shape clear cover 1 having a bottom portion 1a to act as a light emitting surface, and a side wall portion 1b folded down from the bottom portion 1a so that a surface of the side wall portion 1b may be substantially perpendicular to the light emitting surface of the bottom portion 1a. A back frame 3 is provided so as to be facing the bottom portion 1a of the lid shape clear cover 1. This back frame 3 is formed in a mountain configuration having a ridge line 3a at the central portion and gradually lowering apart from the ridge line 3a to the both periphery sides. The back frame 3 is also provided with an LED assembly holder 6 provided in substantially perpendicular direction so as to face the side wall portion 1b of the clear cover 1 with a gap 2 at both side ends 3b, 3b of the ridge line 3a. On the LED assembly holder 6, an LED assembly 5 is fixed having a plurality of light source LED 4 arranged thereon. On the back frame 3, a reflecting surface 3c is formed on the surface facing the clear cover 1.

Space formed between the bottom portion 1a of the clear cover 1 and the reflecting surface 3c of the back frame 3 forms a hollow light guide region 7 for guiding the light emitted from the LED 4.

The clear cover 1 is formed by highly translucent material such as acrylic resin, polycarbonate (PC), etc. However, highly translucent material is not limited only to transparent material. The configuration of the Surface of the clear cover 1 will be mentioned later.

The back frame 3 is formed by metal with high heat conductivity such as aluminum alloys, etc. It has a mountain configuration having the central portion ridge line 3a protruding to the clear cover 1 side and gradually lowering apart from the ridge line 3a to the both periphery sides. With the configuration, the distance between the bottom portion 1b of the clear cover 1 and the reflecting surface 3c of the back frame 3 is varied so as to make the brightness distribution in the light emitting surface of the clear cover 1 uniform. The reflecting surface 3c of the back frame 3 is formed by laminating high reflective and diffuse reflective material such as, for example white PET film or white ink, on the metal or resin member so as to make the brightness distribution in the light emitting surface of the clear cover 1 uniform. Here, as a light diffuse reflective material, a high reflective aluminum with specular reflectivity coated with a light diffuse reflective material can be used other than above examples.

The clear cover 1 and the back frame 3 are fixed on a holder plate provided on a back frame 3 side, though not illustrated, keeping the mutual physical relationship described above. On the holder plate, control circuit for controlling on/off of LED 4 and constant voltage source, etc. are also loaded, though not illustrated.

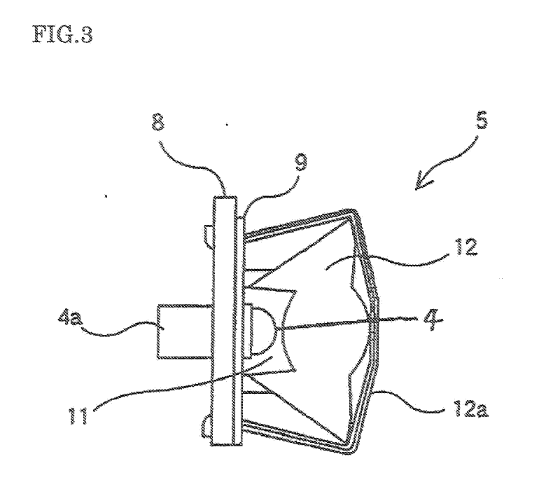

FIG. 3 is a sectional side view of the LED assembly 5. The LED assembly 5 is formed by mounting a number of LED 4 in one row or in a plurality of rows on an LED board 9 provided on a slender heat sink plate 8 having a width to be accommodated on the LED assembly holder 6 of the clear cover 1. A connector 4a for supplying the LED 4 with power is fixed on a opposite side of the heat sink plate 8.

The LED board 9 is made of high heat conductivity metal of aluminum, or aluminum alloy, or ceramics such as aluminum nitride etc. This LED board 9 is fixed to the LED assembly holder 6 of the highly heat conductive back frame 3 through the heat sink plate 8 by a screw, adhesive bond, or by other means. The LED 4 to be mounted on the LED board 9 is composed of white LED, or 3-color LED of red, green, blue arranged with a specified quantity ratio and/or alignment, or a plurality of LED 4 for emitting white light by combining blue LED 4 chip and yellow phosphor, for synthesizing a desired white color.

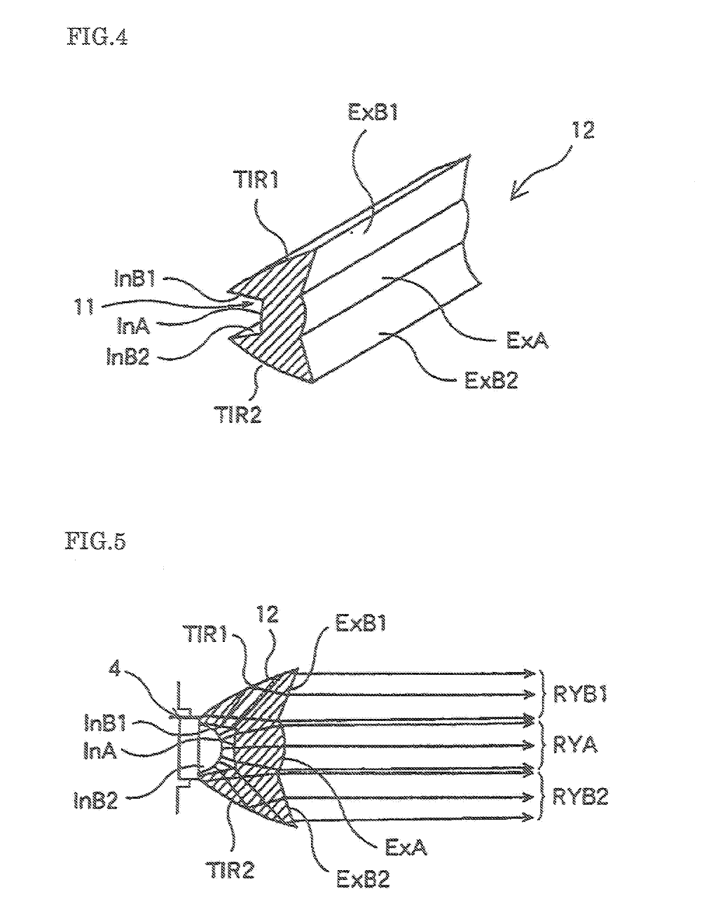

A slender LED collimator 12 on which concave groove 11 to cover the row of LED 4 is formed, is arranged on the side facing the hollow light guide region 7 of the LED board 9, as shown in FIG. 4. This LED collimator 12 is a member for condensing light from the LED 4 mounted on the LED board 9 and for introducing into the hollow light guide region 7. This LED collimator 12 is formed by transparent resin such as acrylic resin or polycarbonate resin or glass. The LED collimator 12 is fixed to the LED board 9 at both ends with holder 12a (FIG. 3).

Further explanation about the LED collimator 12 will be made referring to FIG. 4 and FIG. 5. On the incident side of the LED collimator 12 facing the LED 4, a concave groove 11 is formed. The wall surface of the groove of the concave groove 11 is composed of a convex incident surface InA for introducing the radiated light of the LED 4 with the angles substantially parallel to the optical axis into the collimator main body, and a flat incident surface InB1, InB2 for introducing the radiated light of the LED 4 having a certain angle to the optical axis into the collimator main body. In FIG. 4 and FIG. 5, the side surface situated at the downside and at the upper side become total reflection surface TIR1, TIR2 which totally reflect the light incident to the collimator main body. The light emitting portion of the LED collimator 12 is composed of a convex light emitting surface ExA and concave curved light emitting surface ExB1, ExB2 for reflecting the light totally reflected by total reflection surface TIR1, TIR2 after radiated from incident surface InB1, InB2.

Therefore, by the illumination device 20, the light from the LED 4 can be condensed in a height direction of the hollow light guide region 7 and can be introduced into the hollow light guide region 7, by the LED collimator 12. More specifically, in the LED collimator 12, the light RYA introduced into the incident surface InA from the LED 4 is refracted at convex incident surface InA in the cross-section and emitting surface ExA and is condensed in the height direction of the hollow light guide region 7. The light RYB1, RYB2 introduced into the incident surface InB1, InB2 is condensed in the thickness direction of the hollow light guide region 7, by being totally reflected at the total reflection surface 3c TIR1, TIR2, and by being refracted at the light emitting surface ExB1, ExB2.

The light RYA, RYB1, RYB2 emitted from the LED collimator 12 into the hollow light guide region 7 is reflected in the clear cover 1 direction by the reflection surface 3c of the back frame 3 and is radiated from the emitting surface of the clear cover 1 with high and uniform brightness.

Next, comparison between the illumination devices with the LED collimator 12 and without the LED collimator 12 will be explained.

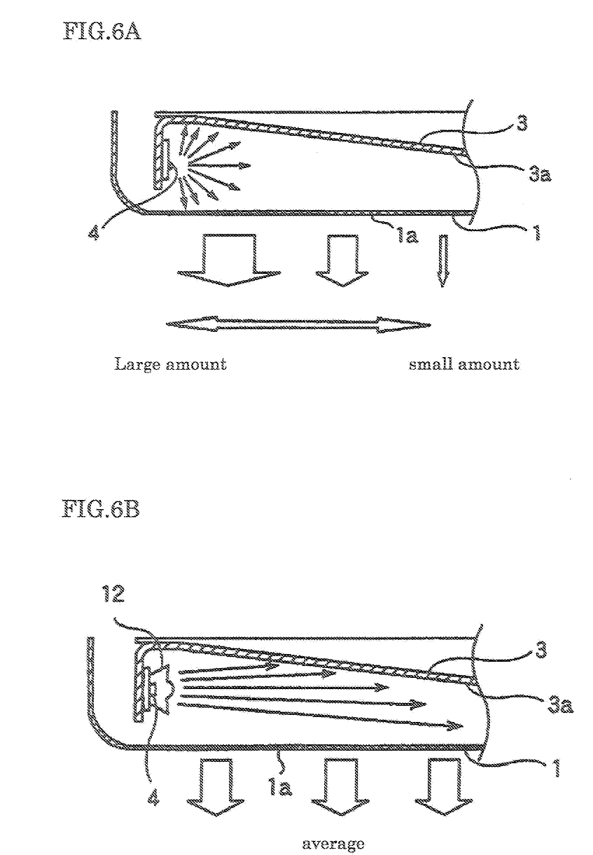

FIG. 6A is a schematic diagram of the illumination device without LED collimator 12 showing light paths from the LED 4. FIG. 6B is a schematic diagram of the illumination device with the LED collimator 12 showing the light paths from the LED 4. The light distribution from the LED 4 shows so called Lambert distribution when LED collimator 12 is not equipped. That is, the light is dispersed to many directions in the hollow light guide region 7 just after the emission from the LED 4, forming diverging rays. Since the light traveling in the straight forward to the hollow light guide region 7 is only a part of the diverging rays, the light strength is weak. For this reason, extremely weak light reaches to the central portion 3a of the hollow light guide region 7. The amount of light received at the bottom portion 1a of the clear cover 1, i.e. the light emitting surface, is great at the LED 4 side and decreases as a distance away from the LED 4 side. As the result, the light from the light emitting surface 1a of the clear cover 1 concentrates in front of the LED 4 and the amount of light decreases as a distance away from the LED 4 side, as shown in FIG. 6A. Therefore, the clear cover 1 in this case becomes an uneven flat light source with nonuniform light distribution.

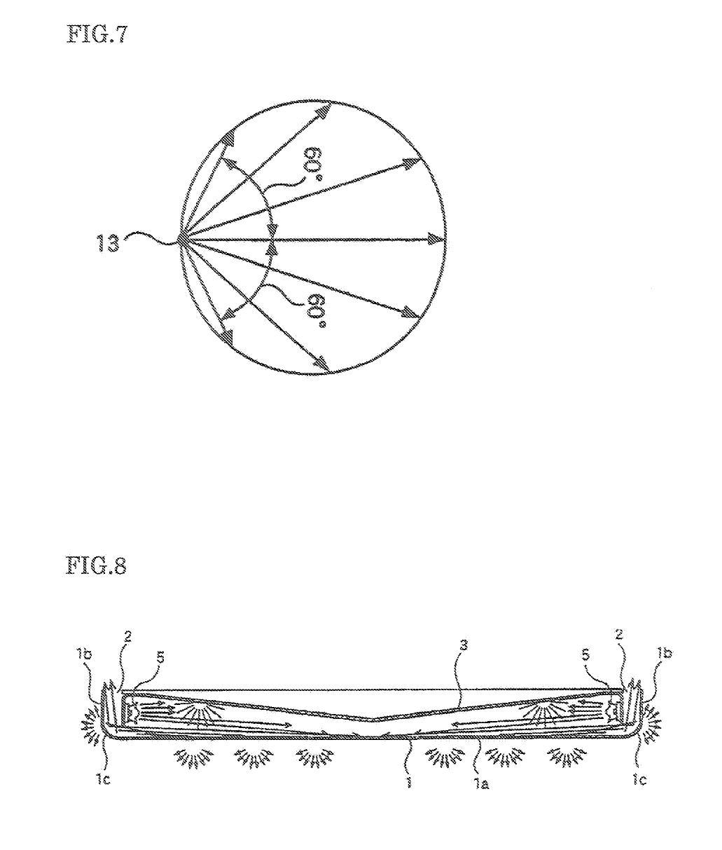

The Lambert distribution is shown in FIG. 7 as an example of light distribution of the point light source 13. The Lambert distribution is defined as intensity distribution of light energy radiated from a point light source 13, which is a spherical configuration. The distribution in FIG. 7 shows a cross-section of a sphere. In this distribution, maximum energy radiation is made in the normal direction of a surface of the light source. If the radiation direction of the maximum energy E is assumed as θ=0°, the light energy of the light flux radiated to the angleθdirection decreases as θ increases. The light energy of the light flux radiated to the angleθdirection becomes one half of the maximum value E (half value) at an angle of θh=60° and the energy radiation in a solid angle decreases to one fourth.

On the other hand, when the LED collimator 12 is equipped, the light from the LED 4 is condensed toward the center ridge line 3a direction of the back frame 3 inside the hollow light guide region 7, as shown in FIG. 6B. The light advances inside the hollow light guide region 7 substantially parallel to the bottom portion 1a of the clear cover 1, and some portion of the light is reflected by the reflection plane 3c of the back frame 3 and proceeds toward the bottom portion 1a of the clear cover 1. Therefore, the amount of light received at the bottom portion 1a of the clear cover 1 is substantially equal at the LED collimator 12 side and at the position apart from there. As the result, the amount of radiated light from the bottom portion 1a of the clear cover 1, i.e. light emitting plane is substantially uniform in front of the LED collimator 12 and at a portion apart from there, for example, near the center ridge line 3a. Accordingly, the clear cover 1 in this case acts as a uniform flat light source with even brightness.

One portion of the light condensed by the LED collimator 12 proceeds passing by between the mountain like center ridge line 3a of the back frame 3 and the clear cover 1, and is reflected by the curved surface of curved portion 1c which is the connected portion of the bottom portion 1a and the side wall portion 1b of the clear cover 1, as shown in FIG. 8. The light reflected by the curved surface of curved portion 1c is divided by the reflection angle at the curved surface. One reflected light is reflected by the side wall portion 1a of the clear cover 1, and another light is not reflected by the side wall portion 1a of the clear cover 1 and proceed straight outside through the gap 2.

The light radiate the side wall portion 1a of the clear cover 1 is reflected by the side wall portion 1a having the side wall portion 1a act as a light emitting surface. Thus, the illumination device 20 emits light from the side surface (side wall portion 1a) as if it is the conventional illumination device using fluorescent lamps. Since plural LED is used as a light source, the illumination device 20 is made thinner than the device using fluorescent lamps.

On the other hand, the reflected light passed straight through the gap 2 without radiating the side wall portion 1a of the clear cover 1 at a certain reflection angle proceeds outside of the illumination device 20 through the gap between the clear cover 1 and the back frame 3 to form indirect illumination.

In other words, because gap 2 is formed between the region of holding the LED 4 of the back frame 3, and the side wall portion 1a of the clear cover 1, one portion of the light reflected by the curved portion 1c which is a connecting portion of the bottom portion 1a and the side wall portion 1b of the clear cover 1 proceeds outside through the gap 2 between the clear cover 1 and the back frame 3 to form indirect illumination.

Therefore, the illumination device 20 according to the present embodiment provides indirect illumination and a uniform direct flat illumination at the same time.

Next, the clear cover 1 will be explained in detail. As described above, the clear cover 1 is formed by highly translucent material such as acrylic resin, PC (polycarbonate), etc. In its configuration, at least one side of the clear cover 1 is made concave-convex.

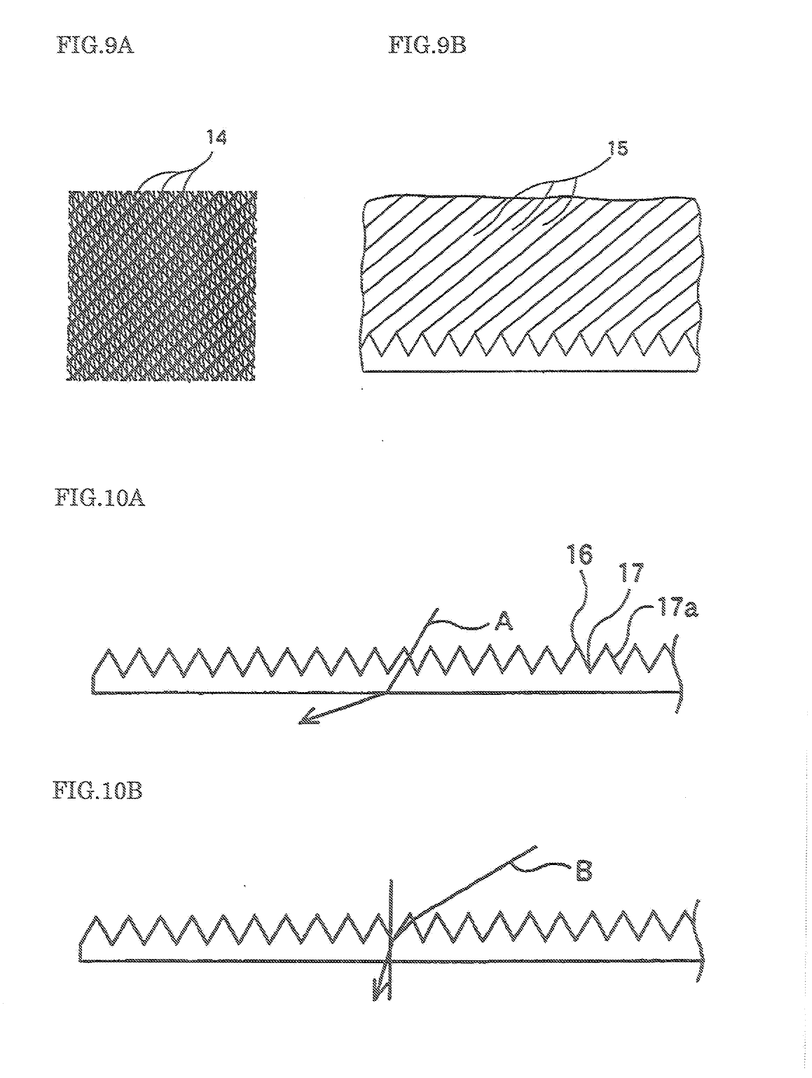

That is, at least one side of the bottom portion 1a of the clear cover 1 is processed to form an array surface composed of a plurality of prism 14 which is small pyramid-shaped projection with triangular cross section, as shown in FIG. 9A, or is processed to form an array surface composed of small prism 15 with triangular cross section, as shown in FIG. 9B.

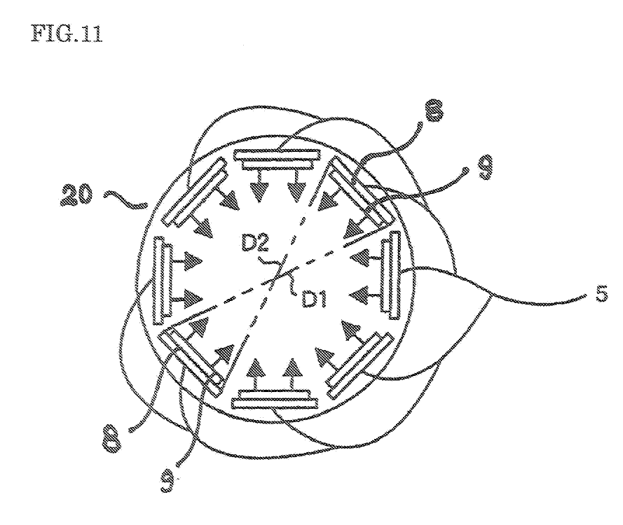

The function of the array surface of the small prism 15 shown in FIG. 9B will be explained referring to FIG. 10A and FIG. 10B. The light radiated from the LED 4 is condensed by the LED collimator 12 and proceeds to radiate the reflection surface 3c of the back frame 3, where the light is reflected in all the directions by Lambert reflection. The light further proceeds toward the clear cover 1 and enters to the clear cover 1.

One portion of, the light entered into the clear cover 1, which entered vertically to the valley portion 16 of the small prism 15, as shown by the arrow A in FIG. 10A, proceeds straight downward through the clear cover 1. On the other hand, another portion of the light entered from oblique direction to the ridge line 17a of the small prism mountain 17, as shown by the arrow B in FIG. 10B, is refracted according to the incident angle and proceeds to the direction of the side wall portion 1b of the clear cover 1.

The explanation about the function of the array surface of the small prism 14 with triangular cross section is omitted since the only difference is that the prism 14 has more inclined planes (3 planes) than the prism 15. So, the small prism 14 has almost the same function as the prism 15 has.

Because the clear cover 1 is made of highly translucent material, the transmission amount of the light is great, and the diffusion and scattering effect of the prism etc. helps to supply an illumination device with a bright and uniform light distribution.

various embodiments of the illumination device 20 may be possible relating to the number or the arrangement of the LED assembly 5 as a light source according to the configuration etc. of the back frame 3.

An arrangement plan of the LED assembly 5 in the case of the illumination device 20 having a plane view of circular configuration is shown in FIG. 11. In this case, the plane view of the LED assembly 5 shows that it is arranged in substantially regular octagon configuration layout inside the circular illumination device 20, in which each of opposite LED assembly 5 forms a pair. Therefore, basically the above-mentioned explanation can be optically realized between the pair of LED assembly 5. Here, the layout of the LED assembly 5 was regular octagon configuration in the embodiment, however, it is not limited to the regular octagon configuration, but polygon of any kind can be selected.

Further, if the heat sink 8 is made in circular arc configuration and a flexible board is used as the LED board 9, the LED assembly 5 can be arranged on a ring configuration as a whole.

The configuration of the reflection surface 3c of the clear cover 1 of the back frame 1 is an isosceles triangle with each LED assembly 5 on one side as shown by the two-dot chain line D1, D2 in FIG. 11 for a pair of LED assembly 5 arranged at opposite position, for example. The corners of these isosceles triangles overlap with each other at the center of circular illumination device 20. So, the configuration of the back frame 1 is symmetric about the center of the illumination device 20.

The transverse cross section of the back frame 1 is not limited to slope of straight line, but a circular arc of upward convex can be used.

The illumination device 20 described above can be used effectively also as illumination for signboard etc. fixed on the wall, besides the illumination in a room.

The present invention is not limited to the embodiment described above, but in the implementation stage, it can be embodied by modifying the component member within the range not to deviate from the substance of the invention. And, various inventions can be made by properly combining the plurality of components disclosed in the above embodiment. For example, some components may be omitted from the total components. And, components from different embodiments may be combined appropriately.

1. An illumination device comprising:
a translucent clear cover in the periphery of a light emitting plane having a side wall portion folded down from the light emitting plane,
a back frame placed in the clear cover with a reflecting plane facing the light emitting plane of the clear cover, and
an LED assembly held at the end portion of the back frame having a plurality of LED mounted thereon,
wherein a hollow light guide region for conducting the light radiated from the LED assembly is formed between the clear cover and the back frame, and
a gap is formed between the LED assembly holder of the back frame and the side wall of the clear cover opposite to the holder.

2. An illumination device according to claim 1, wherein the clear cover is formed in a lid configuration having a bottom portion forming the light emitting plane and a side wall portion folded down from the bottom portion, the back frame is formed in a mountain configuration having a slope gradually lowering from the top portion to the periphery, and the LED assembly holder arranged substantially in a vertical direction so as to surface the side wall portion of the clear cover with a gap.

3. An illumination device according to claim 2, wherein a reflecting surface is formed on the mountain shaped slope of the back frame, which is opposite to the clear cover.

4. An illumination device according to claim 3, wherein a collimator for condensing the emitted light from the LED assembly is arranged on the light emitting side of the LED assembly mounted on the LED assembly holder.

5. An illumination device according to claim 4, wherein the travelling direction of the light emitted from the collimator is substantially parallel with the light emitting surface of the clear cover.

6. An illumination device according to claim 1, wherein at least one side of the clear cover is provided with convex and concave pattern for causing diffused reflection of the emitted light from the LED assembly.

7. An illumination device according to claim 4, wherein the bottom portion and the side wall portion of the clear cover are connected each other with curved surface, and the light emitted from the LEDs which is reflected by the reflection surface is introduced outside the back frame through the gap formed by the side wall portion of the clear cover and the LED assembly holder of the back frame.

8. An illumination device according to claim 3, wherein the back frame is made of metal and the reflection surface is formed by coating the surface of the metal with a translucent diffusion material.

9. An illumination device according to claim 2, wherein the height of the hollow light guide region is formed to be lowest at the top portion of the back frame and to be getting higher than the top portion toward the periphery.

10. An illumination device according to claim 9, wherein the top portion of the back frame is located at substantially center of the right and left ends of the back frame, and each of the LED assembly is arranged at the right and left ends of the back frame to face each other interposing the top portion at the center.

11. An illumination device according to claim 4, wherein the collimator is composed of a slender main body made of transparent resin or glass,
a concave groove formed along the longitudinal direction of the main body for receiving light emitted from the LED assembly,
an emitting surface formed in a longitudinal direction on the opposite side of the main body facing the concave groove, and
a total reflection surface for connecting the emitting surface and the concave groove.

12. An illumination device according to claim 11, wherein the configuration of the concave groove in the cross section perpendicular to the longitudinal direction of the main body is formed by a convex back wall and a flat top and lower surface.

13. An illumination device according to claim 12, wherein the configuration of the emitting surface of the collimator in the cross section perpendicular to the longitudinal direction of the main body is formed by a convex central portion and a concave curved surface portion extending to upper and lower sides from the central portion.
